(19) United States
(12) Patent Application Publication
(10) Pub. No.: US 2015/0279242 A1
(43) Pub. Date: Oct. 1, 2015

(54) CONTINUOUS FEED MEDIA WITH ATTACHED LAMINATION LAYER

(71) Applicants: Kevin M. Parks, Hillsboro, OR (US); Andrew J. Sobiesczyk, Beaverton, OR (US); Caleb J. Mayfield, Canby, OR (US)

(72) Inventors: Kevin M. Parks, Hillsboro, OR (US); Andrew J. Sobiesczyk, Beaverton, OR (US); Caleb J. Mayfield, Canby, OR (US)

(21) Appl. No.: 14/242,759

(22) Filed: Apr. 1, 2014

(51) Int. Cl. G09F 3/02; G09F 3/10

(52) U.S. Cl. CPC G09F 3/02; G09F 3/10; G09F 2003/0201; G09F 2003/0257

(57) ABSTRACT

Continuous feed media including an attached laminating layer for printing labels and laminating them. The continuous feed media includes a substrate, an adhesive, and a lining. The substrate has a first face and a second face opposite the substrate from the first face. The first face is divided into a printing portion and a protecting portion laterally adjacent to the printing portion. The adhesive is disposed on the protecting portion and the lining is disposed on the adhesive. The adhesive is configured to selectively release the lining. The protecting portion is configured to adhere to and protect the printing portion when the lining is removed and the protecting portion is positioned to overlie the printing portion.

### BACKGROUND

The present disclosure relates generally to continuous feed media. In particular, continuous feed media with an attached lamination layer are described.

In many applications, it is useful to laminate printed media to protect the media from damage due to environmental conditions, such as heat, humidity, abrasion, spills, and dust. Printed media may be laminated in a variety of ways, each way having its own attendant benefits and drawbacks.

One useful and convenient method of laminating printed media is to provide the end user with a means to laminate printed media himself. In fact, there are numerous conventional methods for a user to laminate printed media himself. Media may be said to be self-laminating when it is configured with laminating material for a user to apply over the printed matter on the media.

An example solution for laminating media that is not strictly self-laminating is to provide a user with a supply of laminating material that the user can apply to media after printing on the media. However, the user being required to procure and keep track of a separate supply of laminating material is cumbersome, prone to waste, and inconvenient. Further, the user must determine the appropriate dimensions of laminating material to cut out and apply to the printed media, which is a hassle, time consuming, and prone to error.

Even when existing label media is self-laminating, the laminating portion is often. awkwardly configured and must be trimmed or customized after the fact. Trimming and customizing the laminated portion to correspond appropriately with the printed matter demands time and skill. With conventional self-laminating media, users often find it difficult and inconvenient to fold or otherwise apply non-uniform laminating material over printed subject matter because of the sizing and aligning required.

Some existing approaches to laminating printed media involve providing the user with media die cut to a fixed length and providing the user with laminating material cut to the same length as the die cut media. The fixed length media and laminating material approach is convenient in some respects because the laminating material is complimentarily configured with the media and can be easily adhered to the media without having to cut the laminating material to an appropriate size. However, the fixed length media and laminating material suffers from the serious drawback that the length of media is fixed and can not accommodate text or other printed matter that is longer than the fixed length.

Some conventional laminating solutions require that the user order media with desired subject matter printed on it in advance. The pre-printed media comes with laminating material already applied or ready to be applied to the printed media. The pre-printed media approach is inconvenient because the user must decide in advance what subject matter should be printed on the media, must order large quantities of the printed media, can not change the subject matter to be printed as needed, must wait for the printed media to arrive, and must pay shipping fees to receive the media.

Other known self-laminating media examples limit the end user to hand writing subject matter on the media. In the hand written media examples, the media comes pre-printed with subject matter in the nature of a form with space available for the user to write in relevant data by hand. The media comes with laminating material secured to an end of the media and the user can apply the laminating material over the handwritten portion of the media once the user enters the information.

Handwritten, self-laminating media of this type suffer from significant drawbacks. A major drawback is the need for the user to write subject matter on the media by hand. Handwritten subject matter suffers from legibility, spelling, alignment, scale, accuracy, and efficiency issues that can be more effectively addressed with modern computer software. Further, the known handwritten, self-laminating media solutions limit the area on which a user can add subject matter because the laminating material covers a significant portion of the media where it is secured to the media before being delivered to the user.

Some laminating solutions include printable media with laminating material extending beyond the printable media and require the user to wrap laminating material around the media to laminate the media. The laminating material must he wrapped around the back of the printed media to apply the laminating material over the front of the printed media because the adhesive used to secure the laminating material to the printed media is disposed on the opposite side of the printed subject matter.

Media requiring that laminating material be wrapped around its backside is not suitable for folding the laminating material over the printed subject matter on the media, which is useful when applying printed media to planar surfaces. Rather, media requiring that laminating material be wrapped around the media is appropriate primarily for applying printed labels to small objects like cords and test tubes because the laminating material can be wrapped around the object and also around the printed media to secure the media to the object. Thus, the wrap-style self-laminating media examples are limited to being attached to relatively small objects.

Thus, there exists a need for continuous feed media that improve upon and advance the design of known continuous feed media. Examples of new and useful continuous feed media relevant to the needs existing in the field are discussed below.

### SUMMARY

The present disclosure is directed to continuous feed media with an attached lamination layer for printing labels and laminating them. The continuous feed media includes a substrate having a first face, divided into a printing portion and a protecting portion laterally adjacent to the printing portion, and a second face opposite the substrate from the first face. The media further includes an adhesive disposed on the protection portion and a lining disposed on the adhesive, wherein the adhesive is configured to selectively release the lining. The protecting portion is configured to adhere to and protect the printing portion when the lining is removed and the protecting portion is positioned to overlie the printing portion.

In some examples the continuous feed media include a second adhesive disposed on a portion of the second face opposite the printing portion of the first face. A second lining is disposed on the second adhesive, and the second adhesive is configured to selectively release the second lining and adhere the second surface to a target surface. In some further examples, the continuous feed media includes a fold line, crease, bend, or perforation on the first face dividing the printing portion and the protecting portion. The substrate is folded along the fold line such that a portion of the second face opposite the protecting portion of the first face is proximate to the second lining when the substrate is folded onto the roll.

### BRIEF DESCRIPTION OF THE DRAWINGS

FIG. 1 is a front perspective view of a first example of a roll of continuous feed media depicted adjacent to a printing device for printing tags and labels.

FIG. 2A is front perspective view of a roll of continuous feed media

FIG. 2B is a cross-section view of the roll of continuous feed media shown in FIG. 2A depicting a printing portion and a protection portion.

FIG. 2C is a front perspective view of a second example of a roll of continuous feed media.

FIG. 2D is a cross-section view of the roll of continuous feed media shown in FIG. 2C in a first configuration.

FIG. 2E is a cross-section view of the roll of continuous feed media shown in FIG. 2C in a second configuration.

FIG. 2F is a cross-section view of the roll of continuous feed media shown in FIG. 2C in a third configuration.

FIG. 3A is a first schematic view in a series of schematic views of the continuous feed media shown in FIG. 1, the first schematic view depicting a lining being separated from the protecting portion of a printed tag.

FIG. 3B is a second schematic view in the series of schematic views of the continuous feed media shown in FIG. 1, the second schematic view depicting a lining being removed from the protecting portion of the printed tag.

FIG. 3C is a third schematic view in the series of schematic views of the continuous feed media shown in FIG. 1, the third schematic view depicting the protecting portion folded to overlie and protect the printed portion of the printed tag.

FIG. 3D is a fourth schematic view in the series of schematic views of the continuous feed media shown in FIG. 1, the fourth schematic view depicting a finished tag.

FIG. 4A is a first schematic view in a series of schematic views of the second example of a continuous feed media shown in FIG. 2, the fourth schematic view depicting the protecting portion folded to overlie and protect the printed portion of the printed label.

FIG. 4B is a second schematic view in the series of schematic views of the second example of a continuous feed media shown in FIG. 2, depicting a finished label.

FIG. 4C is a third schematic view in the series of schematic views of the second example of a continuous feed media shown in FIG. 2, the third schematic view depicting a liner being removed from a second face of the printing portion and depicting an adhesive configured to adhere the label to a target surface.

FIG. 5 is a front perspective view of a third example of a roll of continuous feed media depicted adjacent to a printing device for printing labels; the roll of continuous feed media is configured to pass through a feed mechanism of the printing device with a protecting portion folded beneath a printing portion.

FIG. 6 is a front perspective view and a cross-section view of the continuous feed media shown in FIG. 5, the cross-section view depicting the printing portion including a pre-printed background on a second face.

FIG. 7A is a first schematic view in a series of schematic views of the continuous feed media shown in FIG. 5, the first schematic view depicting the protecting portion being folded out from beneath the printing portion on a printed label.

FIG. 7B is a second schematic view in the series of schematic views of the continuous feed media shown in FIG. 5, the second schematic view depicting a lining being separated from the protecting portion of the printed label.

FIG. 7C is a third schematic view in the series of schematic views of the continuous feed media shown in FIG. 5, the third schematic view depicting a lining being removed from the protecting portion of the printed label.

FIG. 7D is a fourth schematic view in the series of schematic views of the continuous feed media shows in FIG. 5, the fourth schematic view depicting the protecting portion folding over the printing portion to overlie and protect the printing portion.

FIG. 7E is a fifth schematic view in the series of schematic views of the continuous feed media shown in FIG. 5, the fifth schematic view depicting a protected label.

FIG. 7F is a sixth schematic view in the series of schematic views of the continuous feed media shown in FIG. 5, the sixth schematic view depicting a liner being removed from the second face of the printing portion and depicting an adhesive configured to adhere the label to a target surface.

FIG. 8 is a front elevation view of the continuous feed media shown in FIG. 1, depicting a hanging-tag embodiment of a printed label.

FIG. 9 is a front elevation view of the continuous feed media shown in FIG. 2, depicting a printed label adhered to a fouled or dirty target surface.

### DETAILED DESCRIPTION

The disclosed continuous feed media will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various continuous feed media are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The examples of continuous feed media described herein are used to print self-laminating labels and tags. As explained in more detail below, the continuous feed media is configured with a printing portion laterally adjacent to a protecting (or laminating) portion. The reader will see in reviewing the discussion below that the media described herein improves upon the conventional solutions for laminating printable media in a number of key respects.

As can be seen in the figures, the continuous feed media incorporates printable media and laminating material in a single sheet or roll. Thus, the end user does not have to keep track of separate supplies of printable media and laminating material. Further, the end user does not have to contend with the hassle of determining the appropriate dimensions of laminating material in which to cut out of a separate supply to apply to the printed media.

Another way in which the continuous feed media described herein improves on existing label media is that it can be used to print self-laminating labels of variable size. In other words, the continuous feed media is not die cut to specific dimensions, but instead is a continuous sheet of media that enables an end user to print labels of variable or custom lengths. Further, the end-user can print and laminate multiple labels of different lengths utilizing the same roll of continuous feed media.

By incorporating a laterally adjacent protecting portion of laminating material, the continuous feed media reduces or eliminates the trimming and customizing required by conventional label media. Indeed, the laterally adjacent protecting portion of continuous feed media enables an end-user to easily and accurately laminate the printing portion without having to undertake the additional steps of trimming or customizing the laminating material.

Importantly, the continuous feed media described herein are configured to allow the end user to print desired subject matter on the printable media. The end user does not need to order large quantities labels with a given subject matter printed on them or wait for the preprinted labels to be delivered. Rather, with the presently described self-laminating media, the end user has the flexibility and convenience of printing subject matter on the media when desired and in desired quantities.

Another benefit of the presently described self-laminating media is that the user is not limited to adding information by hand. Instead, the user can print all desired information using a computer and a printer to better ensure the resulting label is legible, accurate, aligned, and efficiently prepared.

The present self-laminating media does not require laminating material to be wrapped around the backside of the printable media because the adhesive for the laminating layer is disposed on the same side as the printed matter on the media. Thus, the media described herein may be effectively secured to almost any surface, including planar surfaces, and is not limited to being adhered to small objects via a wrapping process.

Moreover, the continuous feed media described herein can be configured to pass through a feed mechanism of a label printer in a folded configuration to more closely match the maximum printable dimensions of the printer. While some embodiments are configured to pass the media and laminating material through a printer feed mechanism in an unfolded configuration, these embodiments do not utilize the fall printing width of the printer. In unfolded embodiments, only about one-half of the printer's normal printable width can be utilized for printing because the laminating material occupies approximately one-half of the material fed through the printer. In folded configuration examples of the present continuous feed media, the end user may print labels approximately twice the size of unfolded media examples described herein using the same printer.

Thus, the continuous feed media examples described herein offer numerous advantages over existing label media. The laterally adjacent arrangement of the printing portion and protecting portion eliminates the size restrictions and trimming necessities presented by conventional label media. Economically, the continuous feed media examples configured to fold allow users to print labels fully utilizing the printable width of a printer while still providing convenient and effective laminating capabilities.

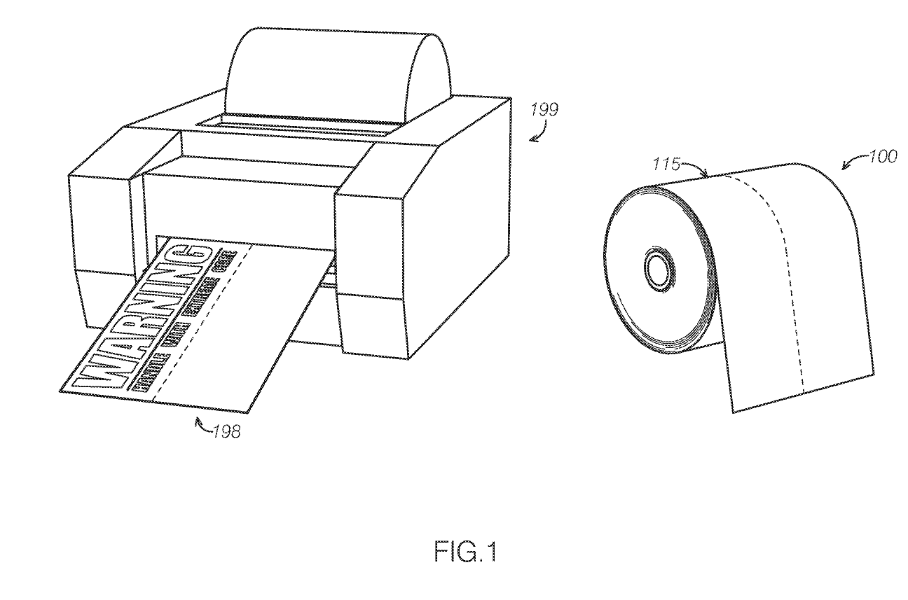

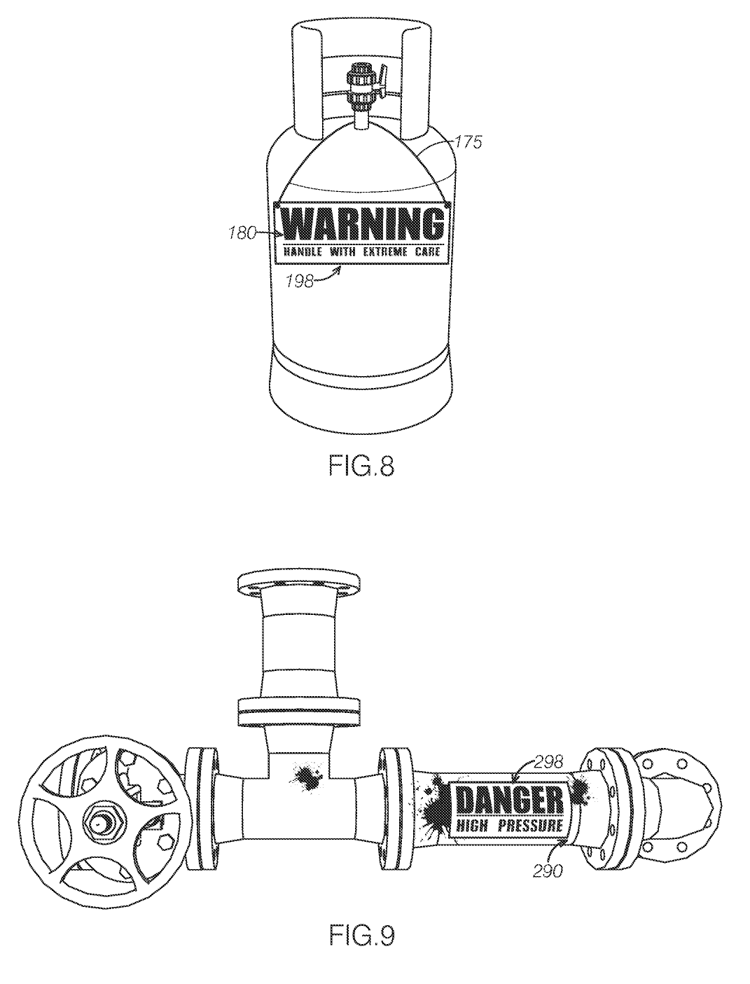

With reference to FIGS. 1, 2, 3, and 8, a first example of continuous feed media, continuous feed media 100, will now be described. Continuous feed media 100 includes a substrate 110, an adhesive 133, and a lining 135. Continuous feed media 100 is configured in a roll 115 and is used to print labels 198. Continuous feed media 100 is configured to he printed upon by a thermal transfer printer 199.

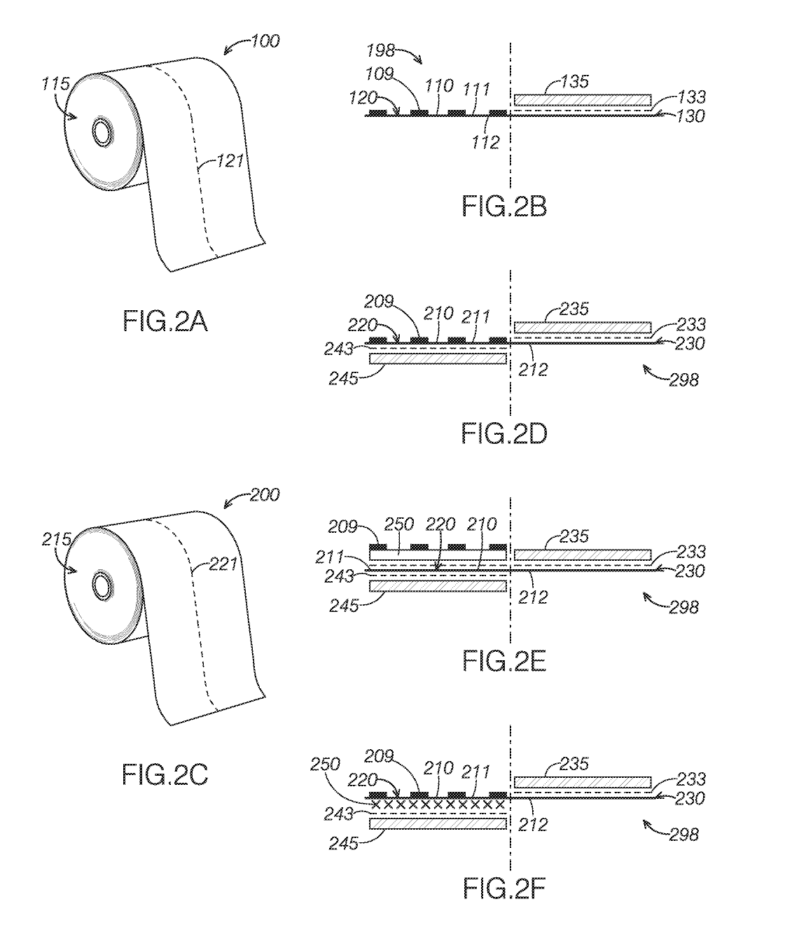

As shown in FIG. 2, substrate 110 includes a first face 111 and a second face 112 opposite substrate 110 from first face 111. In the example shown in FIG. 2, substrate 110 is homogeneously comprised of polyester; both first face 111 and second face 112 are comprised of polyester. Alternatively, the substrate may he homogeneously or heterogeneously comprised of any now known or later developed material, including, but not limited to, plastic, rubber, vinyl, polyester-vinyl combinations, and composites.

As shown in FIG. 2, substrate 110 is transparent. Alternatively, the substrate may be substantially transparent, translucent, or opaque. Indeed, the substrate may include color, pattern, or texture.

As shown most clearly in the roll example oriented in the top left-hand portion of FIG. 2, first face 111 is divided into a printing portion 120 and a protecting portion 130 by boundary line 121. In the FIG. 2 example, first face 111 is divided in substantially equal portions. Alternatively, the first face 111 may be divided in any manner that facilitates or allows the protecting portion to protect all or a portion of the printing portion.

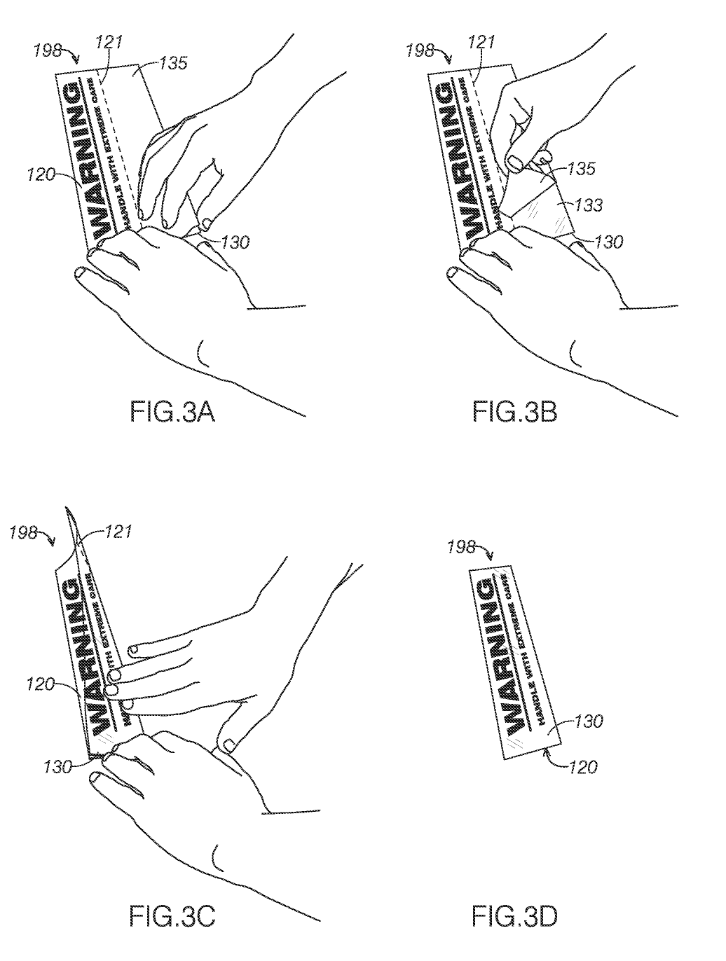

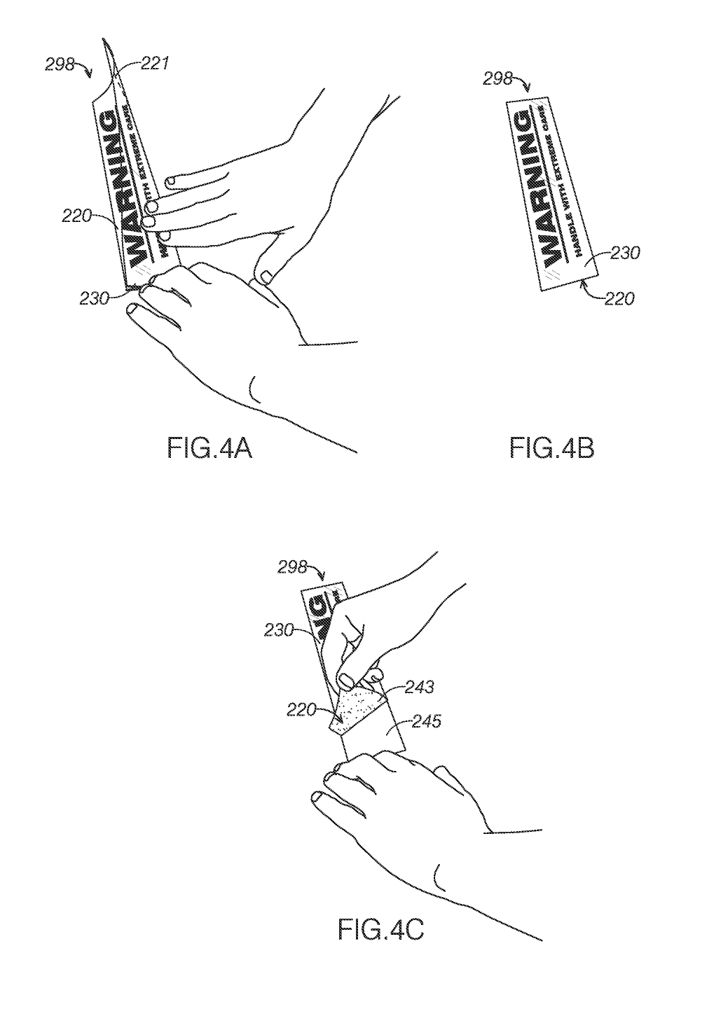

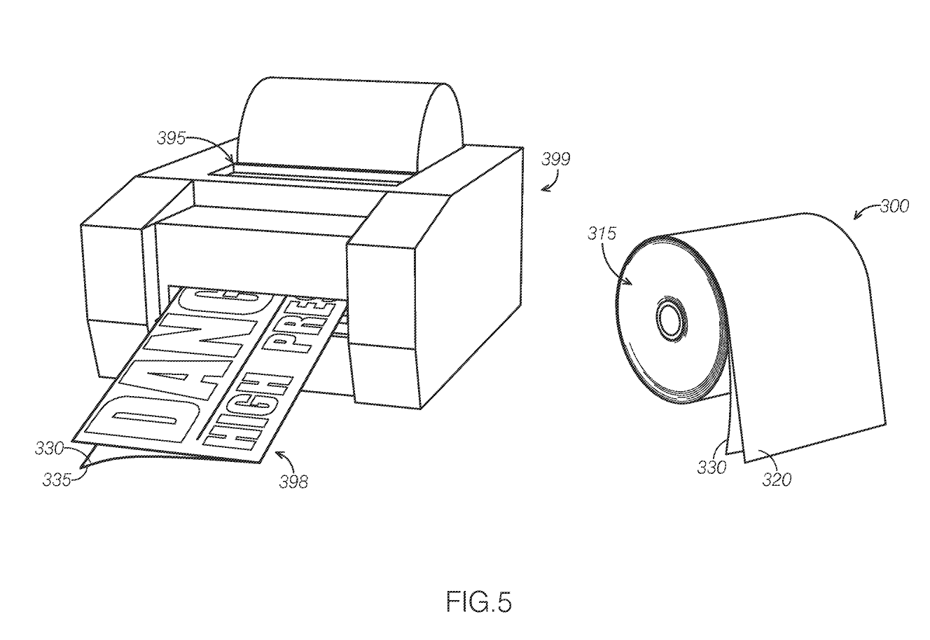

With reference to FIGS. 2-3C, boundary line 121 is a perforation formed in substrate 110 to facilitate folding protecting portion 130 over printing portion 120. In other examples, such as boundary line 221 shown in the roll example on the bottom left hand portion of FIG. 2 and in FIG. 4A, the boundary line may be a crease. In still further examples, the boundary line may be a fold line or bend pre-formed in the substrate.

As shown in FIGS. 1, 2A, and 2B, printing portion 120 is configured to have subject matter printed on it by a printer; namely, thermal transfer printer 199. In the FIG. 1 example, printed subject matter is oriented length-wise on printing portion 120. However, the printed subject matter may be oriented in any orientation or manner on the printing portion. Printed subject matter may be oriented width-wise, diagonally, uni-directionally, or multi-directionally.

In the example shown in FIGS. 2A and 2B printing portion 120 is comprised of polyester. Alternatively, the printing portion may be comprised of any now known or later developed material, including, but not limited to, paper, plastic, rubber, vinyl, polyester-vinyl combinations, and composites.

In the example shown in FIGS. 2A and 2B, printing portion 120 is transparent. Alternatively, the printing portion may be substantially transparent, translucent, or opaque. The printing portion may include color, pattern, or texture.

As depicted in FIGS. 2A, 2B, 3A, and 3B, protecting portion 130 is initially laterally adjacent to printing portion 120 before a user positions protecting portion 130 over printing portion 120 to laminate printing portion 120. Protecting portion 130 is configured to adhere to and protect printing portion 120 when protecting portion 130 is positioned to overlie printing portion 120. Protecting portion 130 is configured to protect printing portion 120 from print-degrading elements including, but not limited to, abrasives, chemicals, and natural elements.

Alternatively to being initially positioned laterally adjacent to the printing portion, the protecting portion may be positioned in any manner that facilitates or allows the protecting portion to be positioned over and protect the printing portion. Acceptable protecting portion initial positions include, but are not limited to, being longitudinally adjacent and beneath the printing portion.

In the example shown in FIGS. 2A and 2B, protecting portion 130 is comprised of polyester. Alternatively, the protecting portion may be comprised of any now known or later developed material, including, but not limited to plastic, rubber, vinyl, polyester-vinyl combinations, and composites.

In the FIGS. 2 and 2B example, protecting portion 130 is transparent. In other examples, the protecting portion may be substantially transparent or translucent. Additionally or alternatively, the protecting portion may be configured to enhance the visibility of the printing portion. The visibility enhancing properties may include, but are not limited to, magnifying, highlighting, and reflecting the printed subject matter.

As shown in FIG. 2B, continuous feed media 100 further includes lining 135 disposed over protecting portion 130. As depicted schematically in FIG. 3B, lining 135 is configured to be selectively separated from protecting portion 130. In FIG. 3B example, lining 135 is configured to be separated from protecting portion 130 and discarded. Alternatively, the lining may be configured for multiple uses and to be selectively replaceable.

In the FIG. 3B example, lining 135 lacks writing or images; lining 135 is blank. Alternatively, the lining may include written instructions for using the continuous feed media. Additionally or alternatively, the lining may include diagrams or illustrations depicting proper use of the continuous feed media.

In the FIG. 2B example, lining 135 is comprised of paper. Additionally or alternatively, the lining may be comprised of any now known or later developed material, including, but not limited to, plastic, rubber, polyester, vinyl, polyester-vinyl combinations, and composites.

As shown most clearly in FIG. 2B, adhesive 133 is disposed between protecting portion 130 and lining 135. In the FIG. 2 example, adhesive 133 removably attaches lining 135 to protecting portion 130. When protecting portion 130 is positioned over printing portion 120, adhesive 133 fixedly attaches protecting portion 130 to printing portion 120. Alternatively, the adhesive may removably attach the protecting portion to the printing portion.

The adhesive may be any conventional or later developed means for securing the applicable layers together, whether permanently or removably. The adhesive may be permanent, reusable, and/or allow the layers to be selectively repositioned as needed before being secured together again. In some examples, the adhesive is a chemical composition configured to bond the layers together.

In other examples, the continuous feed media does not include an adhesive and the protecting portion and the printing portion are themselves configured to selectively bond together. For example, the protecting and printing portions may be configured to utilize static cling to electrostatically attract one layer to the other. In still further examples, the interface between the protecting and printing portions is configured to form a vacuum to bond the layers together.

As depicted schematically in FIGS. 3.A-3D, continuous feed media 100 may be configured as a label 198. First, printing portion 120 is printed with desired information 109 (the thickness of printed subject matter 109 being exaggerated for visual purposes). Second, as shown in FIGS. 3A and 3B, lining 135 is separated and removed from protecting portion 130 to expose adhesive 133. Third, as shown in FIG. 3C, protecting portion 130 is positioned to overlie printing portion 120. Finally, as shown in FIG. 3D, the assembled label 198 is ready for placing on a target surface.

With reference to FIGS. 2C-2F 4, and 9, a second example of continuous feed media, continuous feed media 200, will now be described. Continuous feed media 200 includes many similar or identical features to continuous feed media 100. Thus, for the sake of brevity, each feature of continuous feed media 200 will not be redundantly explained. Rather, key distinctions between continuous feed media 200 and continuous feed media 100 will be described in detail and the reader should reference the discussion above for features substantially similar between the two continuous feed media examples.

As can be seen in FIGS. 2D, 2E, 2F, continuous feed media 200 includes a substrate 210, which has a first face 211 and a second face 212 opposite substrate 210 from first face 211. First face 211 is divided into a printing portion 220 and a protecting portion 230 by boundary line 221. Continuous feed media 200 also includes a first lining 235, a first adhesive 233, a second lining 245, a second adhesive 243, and a backing 250. Continuous feed media 200 is configured in a roll 215 and is used to print labels 298.

Continuous feed media 200 differs from continuous feed media 100 in that continuous feed media 200 includes second lining 245 and second adhesive 243 for adhering second face 212 to a target surface 290. Additionally, in the configuration example shown in FIG. 2E, continuous feed media 200 includes backing layer 250 on which a printer prints the end user's desired subject matter rather than printing the desired subject matter directly on first face 211 of printing portion 220 as with continuous feed media 100. In the FIG. 2F configuration example, continuous feed media 200 includes backing layer 250, but the media is configured such that a printer prints subject matter onto printing portion 220 of substrate 210 rather than onto backing layer 250 as in the FIG. 2E example.

As shown in FIGS. 2D, 2E, and 2F, second lining 245 is disposed under the portion of second face 212 that is under printing portion 220 of substrate 210. Second lining 245 is configured to be selectively separated from second face 212. In the examples shown in FIGS. 2D, 2E, and 2F, second lining 245 is configured to be separated from second face 212 and discarded. Alternatively, the second lining may be configured for multiple uses and to be selectively replaceable.

In the examples shown in. FIGS. 2D, 2E, and 2F, second lining 245 is comprised of paper. Additionally or alternatively, the second lining may be comprised of any now known or later developed material, including, but not limited to, plastic, rubber, polyester, vinyl, polyester-vinyl combinations, and composites.

With reference to FIGS. 2D, 2E, and 2F and to FIG. 9, second adhesive 243 is disposed between second face 212 and second lining 245. Second adhesive 243 is configured to fixedly adhere second face 212 to target surface 290. In the example depicted in FIGS. 2D, 2E, and 2F and in FIG. 9, second adhesive 243 is configured to adhere second face 212 to either pristine or fouled target surfaces 290. Alternatively, the second adhesive may removably adhere the second face to the target surface.

In the FIGS. 2D, 2E, and 2F examples, second adhesive 243 is permanent, non-water soluble, and non-solvent soluble. Alternatively, the second adhesive may be water-soluble or solvent-soluble.

In the examples shown in FIGS. 2D, 2E, and 2F, second adhesive 243 is substantially transparent. Alternatively, the second adhesive may be colored, translucent, or opaque.

As shown most clearly in FIG. 2E, backing layer 250 overlies and is laminated or adhered to printing portion 220 with first adhesive 233. In some examples, the backing layer has its own adhesive. Backing layer 250 may be laminated or adhered to printing portion 220 on first face 211 or on second face 212. In the FIG. 2F example, backing layer 250 is printed onto printing portion 220 rather than defining a separate layer as shown in FIG. 2E.

In the example shown in FIG. 2E, hacking layer 250 is a solid color without pattern. Additionally or alternatively, the backing layer may have a pattern or visibility property that facilitates, allows, or improves visibility of printed subject matter. Examples of acceptable patterns include, but are not limited to, outlining, striping, highlighting, and underlining. Acceptable visibility related properties include, magnifying, highlighting, and reflecting the printed subject matter.

In the example shown in FIG. 2E, backing layer 250 is white and indicia 209 is printed onto backing layer 250. Alternatively, the backing layer may be any color that facilitates, allows, or improves visibility of subject matter printed thereon. A wide variety of printing color and backing layer color combinations are contemplated to enhance visibility of the printing.

As depicted schematically in FIGS. 4A-4C, continuous feed media 200 may be configured as label 298. First, printing portion 220 is printed with desired information 209 (the thickness of printed subject matter 209 being exarerated for visual purposes), and first lining 235 is separated and removed from protecting portion 230 to expose adhesive 233. The adhesive may be clear, colored, or opaque as appropriate for a given application.

Second, as shown in FIG. 4A, protecting portion 230 is positioned to overlie printing portion 220. Third, as shown in FIG. 4B, the assembled label 298 is complete. Finally, as shown in FIG. 4C, second lining 245 is removed from printing portion 220 and label 298 may be placed on a target surface 290 (as shown in. FIG. 9),

Turning attention to FIGS. 5-7, a third example of continuous feed media, continuous feed media 300, will now be described. Continuous feed media 300 includes a substrate 310, which has a first face 311 and a second face 312 opposite substrate 310 from first face 311. First face 311 is divided into a printing portion 320 and a protecting portion 330 by a boundary line (not expresslly pictured). Continuous feed media 300 further includes a first lining 335, a first adhesive 333, a second lining 345, a second adhesive 343, and a backing layer 350. Continuous feed media 300 is configured in a roll 315 and is used to print labels 398.

First face 311 defines a fold line (not expressly pictured) along which substrate 310 is folded to allow continuous feed label media 300 to lay flat and pass through a feed mechanism 395 of a thermal transfer printer 399 in a folded configuration. Thus, printing portion 320 comprises the entire exposed surface of continuous feed media 300 when rolled on roll 315. In other words, the portion of second face 312 under protecting portion 330 is folded proximate second lining 345 when rolled on roll 315. Additionally or alternatively to a fold line, the first face may define a crease, bend, or perforation to help the continuous feed media to lay flat when folded about the crease, bend, or perforation.

As discussed above, in some embodiments of the present invention, the label media is configured to pass through printer feed mechanisms in an unfolded configuration, which does not utilize the full width of printer feed mechanisms. If an end-user desires to print larger labels with media examples not configured to fold, the end-user may need to utilize a printer with a larger feed mechanism.

Conversely, continuous feed media 300 facilitates or allows printing subject matter on substantially all of printing portion 320; continuous feed media 300 is configured to pass through feed mechanism 395 in a folded configuration. Thus, continuous feed media 300 allows end users to print labels using the fall printing width capabilities of a given printer while still providing convenient and effective means for laminating printing portion 320 after printing indicia on it.

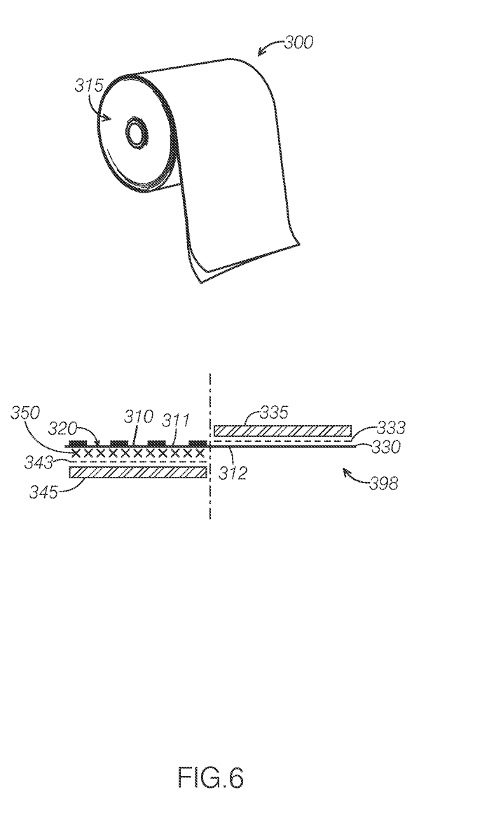

As shown in FIG. 6, first face 311 includes printing portion 320 and protecting portion 330 laterally adjacent to printing portion 320. As in other embodiments, second lining 345 is disposed under printing portion 330. Moreover, substrate 310 is folded such that a portion of second face 312 opposite protecting portion 330 of first face 311 is proximate to second lining 345 when substrate 310 is folded onto roll 315.

Shown most clearly in FIG. 6, backing layer 350 is disposed on second face 312 under printing portion 320. Alternatively, the backing layer may be disposed over the printing portion on the first face.

As shown in FIG. 6, backing layer 350 is flexographically printed prior to delivery to an end-user by a continuous feed media 300 manufacturer. Alternatively, the backing layer may be applied in any manner now known or later developed, including, but not limited to spraying, inking, and rolling.

In the example shown in FIG. 6, pre-printed backing 350 is configured to enhance visibility of printing portion 320; pre-printed backing 350 is reflective. Additionally or alternatively the backing may be configured in any pattern that enhances or improves visibility of printing on the printing portion. Examples of acceptable patterns include, but are not limited to, outlining, striping, highlighting, and underlining.

Additionally or alternatively, the backing may include any color or property that enhances or improves visibility of printed subject matter on the printing portion. Examples of acceptable colors and properties include, but are not limited to, red, yellow, black, fluorescent, and iridescent.

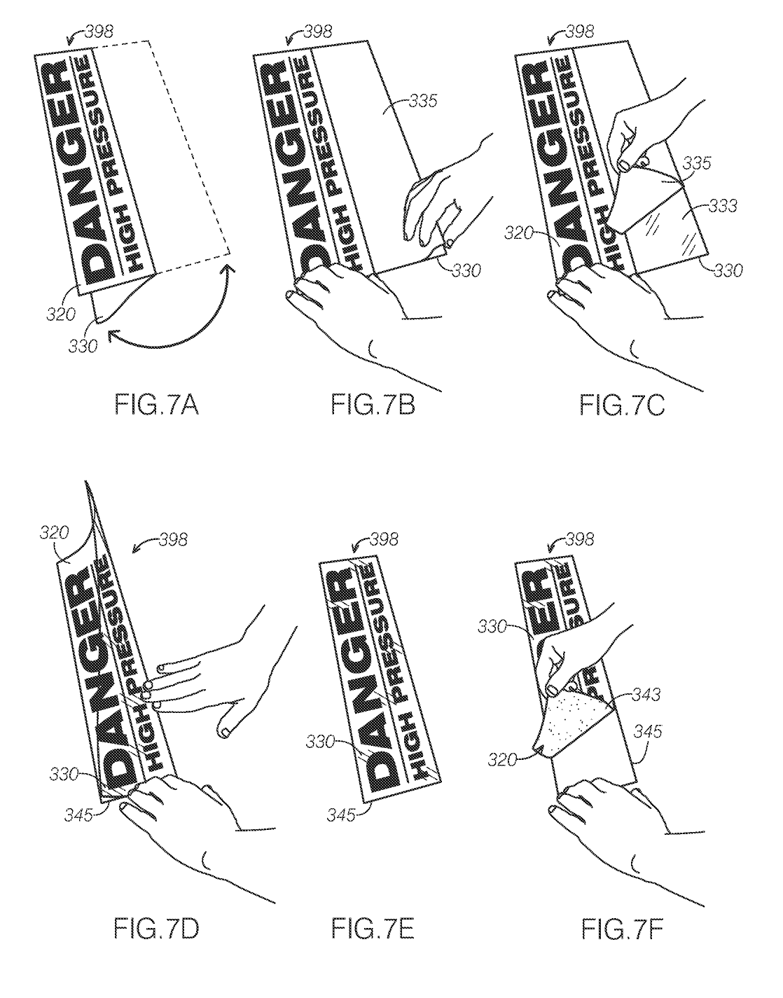

As depicted schematically in FIGS. 7A-7F, continuous feed media 300 may be configured as label 398. First, printing portion 320 is printed with desired information. Second, as shoe in FIG. 7A, protecting portion 330 is unfolded from beneath printing portion 320. Third, as shown in FIGS. 7B and 7C, first lining 335 is separated and removed from protecting portion 330 to expose adhesive 333. Fourth, as shown n FIG. 7D, protecting portion 330 is positioned to overlie printing portion 320. Fifth, as shown in FIG. 7E, the assembled label 398 is complete. Finally, as shown in FIG. 7F, second lining 345 is removed from printing portion 320 and label 398 may be placed on a target surface.

The disclosure above encompasses multiple distinct inventions with independent utility. While each of these inventions has been disclosed in particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicants reserve the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A roll of continuous feed media for printing labels comprising:
a substrate including:
a first face divided into a printing portion and a protecting portion laterally adjacent to the printing portion, and
a second face opposite the substrate from the first face;
an adhesive disposed on the protecting portion; and
a lining disposed on the adhesive
wherein:
the adhesive is configured to selectively release the lining; and
the protecting portion is configured to adhere to and protect the printing portion when the lining is removed and the protecting portion is positioned to overlie the printing portion.

2. The continuous feed media of claim 1, wherein the printing portion and the protecting portion are separated by a boundary line.

3. The continuous feed media of claim 2, wherein the boundary line defines perforation, crease, bend, or fold line.

4. The continuous feed media of claim 1, wherein the protecting portion and the adhesive are substantially transparent.

5. The continuous feed media of claim 1, wherein the protecting portion is configured to protect the printing portion from print-degrading elements including abrasives, chemicals, ultra violet light, and natural elements.

6. The continuous feed media of claim 1, wherein the protecting portion is configured to enhance visibility of the printing portion.

7. The continuous feed media of claim 1, wherein the adhesive fixedly secures the protecting portion to the printing portion when the lining is removed and the protecting portion is positioned to overlie the printing portion.

8. The continuous feed media of claim 1, further comprising a hanger secured to the substrate to define a hanging tag when the lining is removed and the protecting portion is positioned to overlie the printing portion.

9. A roll of continuous feed media for printing labels comprising:
a substrate including:
a first face divided into a printing portion and a protecting portion laterally adjacent to the printing portion, and
a second face opposite the substrate from the first face;
a first adhesive disposed on the protecting portion;
a first lining disposed on the first adhesive;
a second adhesive disposed on a portion of the second face opposite the printing portion of the first face; and
a second lining disposed on the second adhesive;
wherein:
the first adhesive is configured to selectively release the first lining;
the protecting portion is configured to adhere to and protect the printing portion when the first lining is removed and the protecting portion is positioned to overlie the printing portion; and
the second adhesive is configured to selectively release the second lining and adhere the second face to a target surface.

10. The continuous feed media of claim 9, wherein the second adhesive is opaque.

11. The continuous feed media of claim 9, wherein the protecting portion and the first adhesive are substantially transparent.

12. The continuous feed media of claim 11, wherein the printing portion is substantially transparent.

13. The continuous feed media of claim 9, wherein the printing portion is pre-printed with a visibility characteristic configured to enhance the visibility of the printing portion prior to delivering the roll of continuous feed media to an end-user, the visibility characteristic being one or more of a color, an image, a shape, or a color gradient.

14. The continuous feed media of claim 9, further comprising a backing layer disposed on the printing portion in a position to be printed on by a printer when the continuous feed media passes through a printer.

15. The continuous feed media of claim 9, wherein the second adhesive fixedly adheres the substrate to the target surface.

16. The continuous feed media of claim 9, wherein the second adhesive is configured to adhere the substrate to a fouled target surface.

17. A roll of continuous feed media for printing labels comprising:
a substrate including:
a first face divided into a printing portion and a protecting portion laterally adjacent to the printing portion, and
a second face opposite the substrate from the first face;
a first adhesive disposed on the first face;
a printing layer disposed on a first portion of the first adhesive overlying the printing portion;
a first lining disposed on a second portion of first adhesive overlying the protecting portion;
a second adhesive disposed on a portion of the second face opposite the printing portion of the first face; and
a second lining disposed on the second adhesive;
wherein:
the first adhesive is configured to selectively release the first lining;
the protecting portion is configured to adhere to and protect the printing layer when the first lining is removed and the protecting portion is positioned to overlie the printing portion; and
the second adhesive is configured to selectively release the second lining and adhere the second face to a target surface.

18. The continuous feed media of claim 17, wherein:
the first face defines a fold line dividing the printing portion and the protecting portion; and
the substrate is folded along the fold line such that a portion of the second face opposite the protecting portion of the first face is proximate to the second lining when the substrate is rolled onto the roll.

19. The continuous feed media of claim 17, wherein the substrate is configured to pass through a feed mechanism of a thermal transfer printer in the folded configuration.

20. The continuous feed media of claim 17, wherein the printing portion and the protecting portion are comprised of clear vinyl.
